(19) United States
(12) Patent Application Publication
(10) Pub. No.: US 2022/0351237 A1
(43) Pub. Date: Nov. 3, 2022

(54) A COMPUTER IMPLEMENTED PLATFORM FOR ADVERTISEMENT CAMPAIGNS AND METHOD THEREOF

(71) Applicant: ZIRCA DIGITAL SOLUTIONS PVT. LTD., Mumbai, Maharashtra (IN)

(72) Inventors: Neena Dasgupta, Mumbai (IN); Karan Kumar Gupta, Mumbai (IN)

(21) Appl. No.: 17/283,009

(22) PCT Filed: Oct. 5, 2019
(86) PCT No.: PCT/IB2019/058500

§ 371 Date: Apr. 5, 2021

(30) Foreign Application Priority Data
Oct. 5, 2018 (IN) 201821037843

(51) Int. Cl. G06Q 30/02; G06F 21/31

(52) U.S. Cl. CPC G06Q 30/0243; G06F 21/31

(57) ABSTRACT

The present invention relates to a platform (100) and method for advertisement campaigns. The platform (100) includes computing devices (102) and a processing engine (106). The processing engine (106) includes a memory (108), a processor (110), a database (112), an input module (114), an authentication module (116), a presentation module (118), a service module (120), a logic creation module (122), and a data access module (124). The database (112) stores information related to pre-defined logic rules for services, pre-determined procedures, and pre-determined parameters of services. The input module (114) receives inputs from a computing device (102). The authentication module (116) registers the user, and authenticate the user using an authentication mechanism. The presentation module (118) receives a request from the computing device (102). The service module (120) extracts services from data sources, and selects a service from the extracted services. A logic creation module (122) creates a logic. A data access module (124) provides an access of the service having the generated logic, and transmits the accessed service to the computing device (102).

### TECHNICAL FIELD

The present invention relates to a method and platform for advertisement campaigns, more particularly the invention relates to seamless evaluation and comparison of day-to-day data collation and campaign analysis for advertisement campaigns.

### BACKGROUND

Native advertising is leading digital advertisement growth because of its ability to let brands improve their overall advertisement experience, and to simultaneously let publishers provide better user experience and engagement to their audience. The native advertising is paid content disguised as organic content to ensure it is less intrusive to readers. The native advertising is designed to fit in seamlessly with a publication's original content and layout. The perfect native advertisement is one that people/viewers want to engage with, share or comment on the same.

Further, the competition in industries has resulted in a general improvement in the marketing techniques in the entire industry. A digital marketing industry is spread across almost all the business spectrum. The geophysical barriers have been disappeared by way of the Digital Marketing, thus making marketing possible to all potential customers, suppliers and businesses on earth. It is important to measure the traffic to the main website at it is an important tool for gauging the effectiveness of campaign. Generally, most of the analytics tools measure the total number of new sessions to estimate how many of the visitors/viewers are new and how many are returning. Different marketing channels have different objectives, depending upon goals and where the customer is in the sales funnel, calculating the Return on Investment (ROI) for individual platforms/channels gives better insights into which of the campaigns are driving conversions and sales and which areas need to be revised or dropped.

However, measuring the ROI for digital marketing/advertisement campaigns can be complicated and confusing as marketers currently lack a unified view of how their native content campaigns are performing across Search engine, Social media and Content Discovery Networks. As a result, data collation and daily campaign analysis are both time-consuming and cumbersome processes. When multiple agencies are involved, shifting budgets from one platform to another becomes difficult; there are more paperwork, inter-agency coordination time, and approvals involved.

Hence, there is a need for a common platform that enables the marketers to view and compare performance of the campaign, use new platforms, use/upgrade existing platforms, update/upgrade the campaign contains, strategies, geographic reach, etc., compare and view data comparisons, compare and view platform comparisons, construct product and packs scheme, register and track complaints. Further, the common platform also shall be capable of providing functional facilities to marketers and consumers.

For the reasons stated above, which will become apparent to those skilled in the art upon reading and understanding the specification, there is a need in the art for a platform and method for marketers, to analyse advertisement campaign performance across various systems simultaneously and management of the same for offering better viewership of the customers to a campaign that is useable, scalable and independent of new technology platforms, uses minimum resources that is easy and cost effectively maintained and is portable and can be deployed anywhere in very little time.

### SUMMARY

This summary is provided to introduce concepts related to a computer implemented platform for advertisement campaigns and method thereof. This summary is neither intended to identify essential features of the present invention nor is it intended for use in determining or limiting the scope of the present invention.

For example, various embodiments herein may include one or more computer implemented platforms for advertisement campaigns and methods thereof are provided. In one of the embodiments, a computer implemented method for one or more advertisement campaigns includes a step of storing, in a memory, pre-defined rules related to advertisement campaigns. The method includes a step of generating, by a processor, processing commands based on the pre-defined rules. The method includes a step of storing, in a database, information related to pre-defined logic rules for a plurality of services, pre-determined procedures, and pre-determined parameters of services including advertisements, brands, entities, products, and campaigns. The method includes a step of receiving, by an input module, one or more inputs from at least one computing device associated with a user. The method includes a step of registering, by an authentication module, the user associated with the computing device based on received inputs, and authenticating the registered user using an authentication mechanism. The method includes a step of receiving, by a presentation module, a request from the computing device associated with the authenticated user. The method includes a step of extracting, by a service module, services from one or more data sources, and selecting at least one service from the extracted services based on the request. The method includes a step of creating, by a logic creation module, a logic for the selected service using the stored pre-defined logic rules. The method includes a step of providing, by a data access module, an access of the service having the generated logic. The method includes a step of transmitting, by the data access module, the accessed service to the device associated with the authenticated user.

In another embodiment, a computer implemented platform for one or more advertisement campaigns includes one or more computing devices and a processing engine. Each computing device is associated with a user. The processing engine further includes a memory, a processor, a database, an input module, an authentication module, a presentation module, a service module, a logic creation module, and a data access module. The memory is configured to store pre-defined rules related to advertisement campaigns. The processor is configured to generate processing commands based on the pre-defined rules. The database is configured to store information related to pre-defined logic rules for a plurality of services, pre-determined procedures, and pre-determined parameters of services including advertisements, brands, entities, products, and campaigns. The input module is configured to receive one or more inputs from at least one computing device associated with the user. The authentication module is configured to register the user associated with the computing device based on received inputs, and authenticate the registered user using an authentication mechanism. The presentation module is configured to receive a request from the computing device associated with the authenticated user. The service module is configured to extract services from one or more data sources, and select at least one service from the extracted services based on the request. The logic creation module is configured to create a logic for the selected service using the stored pre-defined logic rules. The data access module is configured to provide an access of the service having the generated logic, and transmit the accessed service to the computing device associated with the authenticated user.

### BRIEF DESCRIPTION OF ACCOMPANYING DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates a block diagram depicting a computer implemented platform for advertisement campaigns, according to an exemplary implementation of the present invention.

FIG. 2 illustrates a schematic diagram depicting interconnection of various layers of the computer implemented platform of FIG. 1, according to an exemplary implementation of the present invention.

FIG. 3 illustrates a schematic diagram depicting logical view of various layers and components, according to an exemplary implementation of the present invention.

FIG. 4 illustrates a schematic diagram depicting directory structure and source files maintained on a server, according to an exemplary implementation of the present invention.

FIG. 5 illustrates a schematic diagram depicting a deployment view of the computer implemented platform of FIG. 1, according to an exemplary implementation of the present invention.

FIG. 6 illustrates a schematic diagram depicting instance details, according to an exemplary implementation of the present invention.

FIG. 7 illustrates a workflow diagram depicting execution and interaction of the computer implemented platform of FIG. 1, according to an exemplary implementation of the present invention.

FIG. 8 illustrates a use case diagram depicting stakeholders' details, according to an exemplary implementation of the present invention.

FIG. 9 illustrates a flow diagram depicting adding time period, according to an exemplary implementation of the present invention.

FIG. 10 illustrates a flow diagram depicting creating jobs, according to an exemplary implementation of the present invention.

FIG. 11 illustrates a flow diagram depicting fetching of publisher performance report data, according to an exemplary implementation of the present invention.

FIG. 12 illustrates a flow diagram depicting processing of publisher performance data, according to an exemplary implementation of the present invention.

FIG. 13 illustrates a flow diagram depicting processing of set latest month, according to an exemplary implementation of the present invention.

FIG. 14 illustrates a flow diagram depicting processing of crawling tag from one or more sources, according to an exemplary implementation of the present invention.

FIG. 15 illustrates a flow diagram depicting creating advertisement campaigns with media plan, according to an exemplary implementation of the present invention.

FIG. 16 illustrates a flowchart depicting a computer implemented platform for one or more advertisement campaigns, according to an exemplary implementation of the present invention.

It should be appreciated by those skilled in the art that any block diagrams herein represent conceptual views of illustrative systems embodying the principles of the present invention. Similarly, it will be appreciated that any flowcharts, flow diagrams, and the like represent various processes which may be substantially represented in computer readable medium and so executed by a computer or processor, whether or not such computer or processor is explicitly shown.

### DETAILED DESCRIPTION

In the following description, for the purpose of explanation, specific details are set forth in order to provide an understanding of the present invention. It will be apparent, however, to one skilled in the art that the present invention may be practiced without these details. One skilled in the art will recognize that embodiments of the present invention, some of which are described below, may be incorporated into a number of systems.

The various embodiments of the present invention provide a computer implemented platform for one or more advertisement campaigns and method thereof. Furthermore, connections between components and/or modules within the figures are not intended to be limited to direct connections. Rather, these components and modules may be modified, re-formatted or otherwise changed by intermediary components and modules.

References in the present invention to “one embodiment” or “an embodiment” mean that a particular feature, structure, characteristic, or function described in connection with the embodiment is included in at least one embodiment of the invention. The appearances of the phrase “in one embodiment” in various places in the specification are not necessarily all referring to the same embodiment.

The platforms and methods described herein are explained using examples with specific details for better understanding. However, the disclosed embodiments can be worked on by a person skilled in the art without the use of these specific details.

Hereinafter, embodiments will be described in detail. For clarity of the description, known constructions and functions will be omitted.

Parts of the description may be presented in terms of operations performed by a computer system, using terms such as data, state, link, fault, packet, and the like, consistent with the manner commonly employed by those skilled in the art to convey the substance of their work to others skilled in the art. As is well understood by those skilled in the art, these quantities take the form of data stored/transferred in the form of non-transitory, computer-readable electrical, magnetic, or optical signals capable of being stored, transferred, combined, and otherwise manipulated through mechanical and electrical components of the computer system; and the term computer system includes general purpose as well as special purpose data processing machines, switches, and the like, that are standalone, adjunct or embedded. For instance, some embodiments may be implemented by a processing system that executes program instructions so as to cause the processing system to perform operations involved in one or more of the methods described herein. The program instructions may be computer-readable code, such as compiled or non-compiled program logic and/or machine code, stored in a data storage that takes the form of a non-transitory computer-readable medium, such as a magnetic, optical, and/or flash data storage medium. Moreover, such processing system and/or data storage may be implemented using a single computer system or may be distributed across multiple computer systems (e.g., servers) that are communicatively linked through a network to allow the computer systems to operate in a coordinated manner.

In one of the embodiments, a computer implemented method for one or more advertisement campaigns includes a step of storing, in a memory, pre-defined rules related to advertisement campaigns. The method includes a step of generating, by a processor, processing commands based on the pre-defined rules. The method includes a step of storing, in a database, information related to pre-defined logic rules for a plurality of services, pre-determined procedures, and pre-determined parameters of services including advertisements, brands, entities, products, and campaigns. The method includes a step of receiving, by an input module, one or more inputs from at least one computing device associated with a user. The method includes a step of registering, by an authentication module, the user associated with the computing device based on received inputs, and authenticating the registered user using an authentication mechanism. The method includes a step of receiving, by a presentation module, a request from the computing device associated with the authenticated user. The method includes a step of extracting, by a service module, services from one or more data sources, and selecting at least one service from the extracted services based on the request. The method includes a step of creating, by a logic creation module, a logic for the selected service using the stored pre-defined logic rules. The method includes a step of providing, by a data access module, an access of the service having the generated logic. The method includes a step of transmitting, by the data access module, the accessed service to the device associated with the authenticated user.

In another implementation, the method includes a step of fetching, by a report scheduler, report data from the data sources based on pre-defined schedule intervals.

In another implementation, the method includes a step of capturing, by the input module, data from the computing devices, and receiving the captured data as one or more inputs.

In another implementation, the services include authorization and authentication services, tool services, technology services, exception handling services, inventory services, provisioning services, invoice services, and any commercial services.

In another implementation, the method includes a step of creating, by the logic creation module, the logic using the stored pre-determined procedures.

In another implementation, the method includes a step of registering, by the authentication module, the user based on the user's information, the information includes a username, a contact number, address, a unique identification number, a user role, location, gender, interests, and any combinations thereof.

In another implementation, the method includes a step of registering by the authentication module, the user based on associated details related to products, brands, advertisements related information, audiences, publishers, and campaign.

In another implementation, the method includes a step of integrating and managing, by an external adaptor, the one or more data sources.

In another implementation, the method includes aggregating, by a data aggregator, campaign data of the services having the created logic.

In another implementation, the method includes a step of applying at least one filter by a category, frequency, start date, end date, data sources advertisers, brands, a pre-determined campaign status, campaign or advertisement contents. The method includes a step of setting a pre-defined currency unit for conversion of current currency using a current currency rate. The method includes a step of aggregating the campaign data of the services.

In another implementation, the method includes a step of displaying, by a display unit, the aggregated data in the form of grid, matrix, a list, a chart, a table, a graph, and any combinations thereof.

In another embodiment, a computer implemented platform for one or more advertisement campaigns includes one or more computing devices and a processing engine. Each computing device is associated with a user. The processing engine further includes a memory, a processor, a database, an input module, an authentication module, a presentation module, a service module, a logic creation module, and a data access module. The memory is configured to store pre-defined rules related to advertisement campaigns. The processor is configured to generate processing commands based on the pre-defined rules. The database is configured to store information related to pre-defined logic rules for a plurality of services, pre-determined procedures, and pre-determined parameters of services including advertisements, brands, entities, products, and campaigns. The input module is configured to receive one or more inputs from at least one computing device associated with the user. The authentication module is configured to register the user associated with the computing device based on received inputs, and authenticate the registered user using an authentication mechanism. The presentation module is configured to receive a request from the computing device associated with the authenticated user. The service module is configured to extract services from one or more data sources, and select at least one service from the extracted services based on the request. The logic creation module is configured to create a logic for the selected service using the stored pre-defined logic rules. The data access module is configured to provide an access of the service having the generated logic, and transmit the accessed service to the computing device associated with the authenticated user.

In another implementation, the processing engine includes a report scheduler. The report schedular is configured to fetch report data from the data sources based on pre-defined schedule intervals.

In another implementation, the input module is configured to capture data from the computing devices and receive the captured data as one or more inputs.

In another implementation, the logic creation module is configured to create the logic using the stored pre-determined procedures.

In another implementation, the platform includes a client-server arrangement.

In another implementation, the one or more devices are located at a client side, and the processing engine is located at a server side in the client-server arrangement.

In another implementation, the authentication module is configured to register the user based on the user's information. The information includes a username, a contact number, address, a unique identification number, a user role, location, gender, interests, and any combinations thereof.

In another implementation, the authentication module is configured to register the user based on associated details related to products, brands, advertisements related information, audiences, publishers, and campaign.

In another implementation, the platform includes an external adaptor configured to integrate and manage said one or more data sources.

In another implementation, the processing engine includes a data aggregator configured to aggregate campaign data of the services having the created logic.

In another implementation, the data aggregator is configured to apply at least one filter by a category, frequency, start date, end date, data sources advertisers, brands, a pre-determined campaign status, campaign or advertisement contents; set a pre-defined currency unit for conversion of current currency using a current currency rate; and aggregate the campaign data of the services.

In another implementation, the one or more devices include a display unit configured to display the aggregated data in the form of grid, matrix, a list, a chart, a table, a graph, and any combinations thereof.

The embodiments herein provide a computer implemented platform for advertisement campaigns and method thereof, more particularly the invention relates to seamless evaluation and comparison of day-to-day data collation and campaign analysis for effective digital marketing. Further, the embodiments may be easily implemented in digital marketing packs management structures. Embodiments may also be implemented as one or more applications performed by stand alone or embedded platforms.

In an embodiment, the platform and method for advertisement campaigns provides effective digital marketing and is in accordance to the marketer's choices, preference and to the benefit across multiple platforms.

In an embodiment, the platform and method can assist marketers with their day-to-day campaign analysis.

In an embodiment, the platform and method enable users to get better insights into which of the campaigns are driving conversions and sales and which areas need to be revised or dropped.

In an embodiment, the platform and method provide a unified view of how marketer's native content campaigns are performing across Search engine, Social media and Content Discovery Networks. As a result, data collation and daily campaign analysis are both becomes non time-consuming and easy processes. When multiple agencies are involved, shifting budgets from one platform to another becomes easy.

In an embodiment, the present invention provides a common platform that enables the marketers to view and compare performance of the campaign, use new platforms, use/upgrade existing platforms, update/upgrade the campaign contains, strategies, geographic reach, etc., compare and view data comparisons, compare and view platform comparisons, construct product and packs scheme, register and track complaints. Further, the common platform is also capable of providing functional facilities to marketers and consumers.

In an embodiment, the present invention provides the platform and method for marketers to analyse campaign performance across various platforms simultaneously and manage the same for offering better viewership of the customers to a campaign that is useable, scalable and independent of new technology platforms, uses minimum resources that is easy and cost effectively maintained and is portable and can be deployed anywhere in very little time.

In an embodiment, the platform and method provide a cloud-based Software as a service (SaaS) platform and method thereof and is independent of device and platform. Social, search, and Content delivery network (CDN) Application programming interface (APIs) have been integrated into the platform to enable campaign monitoring and management from a single dashboard.

Flexibility to upload historical data using either spreadsheets or APIs is also provided. Agencies can run campaigns for multiple clients, and, clients can give their credentials to multiple agencies. Campaigns can also be run globally, and campaign data can be viewed in different parameters from a single dashboard. The platform and method thereof can be used in three modes: self-serve (without execution), self-serve (with execution), and managed.

In an embodiment, a platform and method thereof provide the functionality of:
adaptive user interface, where interface application is rendered properly on wide screens, laptops and desktops;
rendering of the page is optimum considering the huge number of records;
efficient search, filtering on the grid pages;
architecture providing the APIs to integrate with third party application with proper authentication;
architecture being multi-tenant, scalable and modular; and
architecture supporting distributed deployment and clustering.

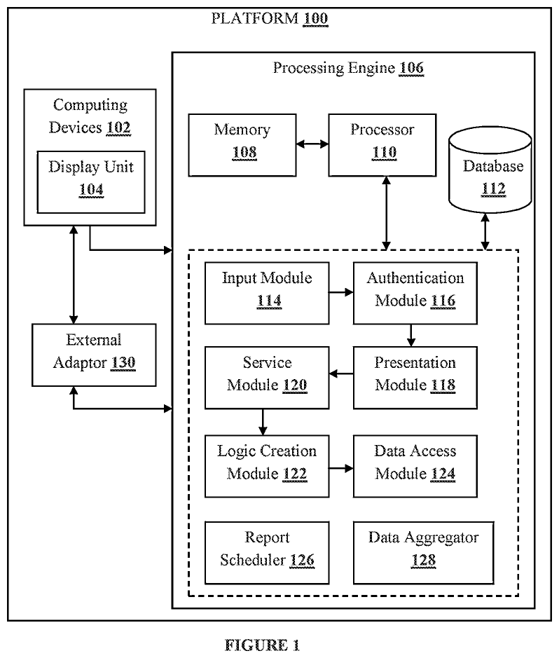

FIG. 1 illustrates a block diagram depicting a computer implemented platform for advertisement campaigns, according to an exemplary implementation of the present invention.

A computer implemented platform for advertisement campaigns (hereinafter referred to as “platform”) (100) includes one or more computing devices (102) and a processing engine (106).

In an embodiment, one or more computing devices (102) can be electronic devices, but are not limited to, a personal computer, a laptop, a tablet, a smartphone/phone, or other web enabled devices. In an embodiment, the one or more computing devices (102) can be associated with multiple users. In one embodiment, each computing device (102) is associated with a user. The user can be a customer, a viewer, an advertiser, a marketer, and the like. Each computing device (102) is communicatively coupled with the processing engine (104) via a network (not shown in a figure). In an embodiment, the network includes wired and wireless networks. Examples of the wired networks include a Wide Area Network (WAN) or a Local Area Network (LAN), a client-server network, a peer-to-peer network, and so forth. Examples of the wireless networks include Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks.

In an embodiment, each computing device (102) includes a display unit (104). The display unit (104) is configured to display the aggregated data in the form of grid, matrix, a list, a chart, a table, a graph, and any combinations thereof.

The processing engine (106) includes a memory (108), a processor (110), a database (112), an input module (114), an authentication module (116), a presentation module (118), a service module (120), a logic creation module (122), and a data access module (124).

The memory (108) is configured to store pre-determined rules related to advertisement campaigns. The memory (108) is also configured to store pre-defined data sources. In an embodiment, the memory (108) can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory (108) also includes a cache memory to work with the processing engine (106) more effectively.

The processor (110) is configured to cooperate with the memory (108) to receive the pre-determined rules. The processor (110) is further configured to generate platform processing commands. In an embodiment, the processor (110) may be implemented as one or more microprocessors, microcomputers, microcontrollers, digital signal processors, central processing units, state machines, logic circuitries, and/or any devices that manipulate signals based on operational instructions. Among other capabilities, the at least one processor (110) is configured to fetch the pre-determined rules from the memory (108) and execute different modules of the platform (100).

The database (112) is configured to store information related to pre-defined logic rules for a plurality of services, pre-determined procedures, and pre-determined parameters of services including advertisements, brands, entities, products, and campaigns. In an embodiment, the database (112) can be implemented as, but is not limited to, an enterprise database, a remote database, a local database, and the like. In one embodiment, the database (112) may themselves be located either within the vicinity of each other or may be located at different geographic locations. In another embodiment, the database (112) can be implemented inside or outside the processing engine (106) and the database (112) can be implemented as a single database.

The input module (114) is configured to receive one or more inputs from at least one computing device (102) associated with the user. The one or more inputs include information related to username, a contact number, address, a unique identification number, a user role, location, gender, interests, and the like. In an embodiment, the input module (114) is configured to capture data from the computing devices (102), and receive captured data as one or more inputs. The input module (114) may consist of web application that basically provides the user interface to view and capture of data through various devices (102). The technologies may be used in this module is used to develop the web application may provide clear separation of concerns between presentation, navigation and application. This technology may also provide support to multiple devices (102). Further, the technology implemented may provide framework for developing responsive, mobile projects and makes front-end development faster and easier. The functionality implemented at the module easily and efficiently scales applications with a single code base, from phones to tablets to desktops with CSS media queries.

The authentication module (116) is configured to cooperate with the input module (114) to receive the inputs. The authentication module (116) is configured to register the user associated with the computing device (102) based on the received inputs, and authenticate the register user using an authentication mechanism. In an embodiment, the authentication module (116) is configured to authenticate the identity of the user based on one or more authentication mechanism. The authentication mechanism includes passwords, pins, patterns, security questions, login credentials, biometrics, tokens, swiping dynamics, typing dynamics, mouse movements, and the like. In an embodiment, the authentication mechanism is pre-determined by the user. The authentication module (116) is configured to register a user to access the platform (100), where the user selects at least one authentication mechanism for verifying his identity to the platform (100). In one embodiment, the authentication module (116) is configured to register the user based in the user's information including a username, a contact number, address, a unique identification number, a user role, location, gender, interests, and any combinations thereof. In another embodiment, the authentication module (116) is configured to register the user based on associated details related to products, brands, advertisements related information, audience, publishers, and campaign.

The presentation module (118) is configured to cooperate with the authentication module (116) to receive the data related to authenticated user. The presentation module (118) is further configured to receive a request from the computing device (102) associated with the authenticated user.

The service module (120) is configured to cooperate with the presentation module (118) to receive the request. The service module (120) is further configured to extract services from one or more data sources, and select at least one service from the extracted services based on the request. In an embodiment, the services include, but are not limited to, authorization and authentication services, tool services, technology services, exception handling services, inventory services, provisioning services, invoice services, and any commercial services.

In an embodiment, the service module (120) may be developed as RESTful Web APIs. The service module (120) may cater to web application as well as third-party integration with the platform and method thereof. Services that are exposed for third-party integration are authenticated services except login service. The data communication may be in JSON format. The Service Module (120) may be servicing to multiple clients. Services may be grouped as business services, authorization and authentication services, tool services, and technologies services. The business services may host all business functionality related services for e.g. Inventory services, Invoice services, Provisioning services. All of these services may be authenticated secure services. Selective services can be publicly accessible depending on the business requirements. The authorization and authentication services may be the group of services that may be related to authentication and authorization. Except login service all other require secured access. Selective services may be publicly accessible depending on the integration, single sign-on or business requirements. The methods in authentication services are divided into two groups. Authenticated methods and un-authenticated methods. Login forgot password are some of the un-authenticated methods of authentication service and logout is the authenticated method. Authentication service is accessed mainly by two ways, web application and third-party application. Authorization information comprises of the access for pages of web application. Design provides the authorization information in two different ways:
Web Application: Authorization information is bundled in a claim and is sent in header to the Web API.
Web APIs: Authorization information is not passed to the third-party application, rather it is maintained in Web APIs application scope and every call verifies the authorization before responding the client.
   The exception handling service where the exception filter reads the exception data, manipulates it and either sends the message back in a user-friendly way as a response or logs it for the developers for a later time. The system configuration section handles the exception filters. The tool services may be the group of services that may be technical services that are internally required for application. These services may mostly be private and accessible to web application and other services groups mentioned above. Configuration, Tenant Management etc are some of the examples of these services. The technologies services by way of which all services may be wrapper over the business/application Module (business/application Module may be represented by DLL). Therefore, in case of single server deployment, overhead of services can be reduced and direct access to business or application Module can be provided to controllers of web application.

The logic creation module (122) is configured to cooperate with the service module (120) to receive the selected service. The logic creation module (122) is further configured to create a logic for the selected service using the stored pre-defined logic rules. In an embodiment, the logic creation module (122) is configured to create the logic using the stored pre-determined procedures.

The data access module (124) is configured to cooperate with the logic creation module (122) to receive the created logic. The data access module (124) is configured to provide an access of the service having the generate logic, and transmit the accessed service to the computing device (102) associated with the authenticated user.

In an embodiment, the processing engine (106) includes a report schedular (126) and a data aggregator (128). Further, the report schedular (126) is configured to fetch report data from the data sources based on the pre-defined schedule intervals.

The data aggregator (128) is configured to aggregate campaign data of the services having the created logic. The data aggregator (128) is further configured to apply at least one filter by a category, frequency, start date, end date, data sources advertisers, brands, a pre-determined campaign status, campaign or advertisement contents, set a pre-defined currency unit for conversion of current currency using a current currency data, and then aggregate the campaign data of the services.

In an embodiment, the platform (100) includes a client-server arrangement, where the one or more computing devices (102) are located at a client side, and the processing engine (106) is located at a server side.

In an embodiment, the platform (100) includes an external adaptor (130). The external adaptor (130) is configured to cooperate with the computing devices (102) and the processing engine (106). The external adaptor (130) is further configured to integrate one or more data sources between the computing devices (102) and the processing engine (106).

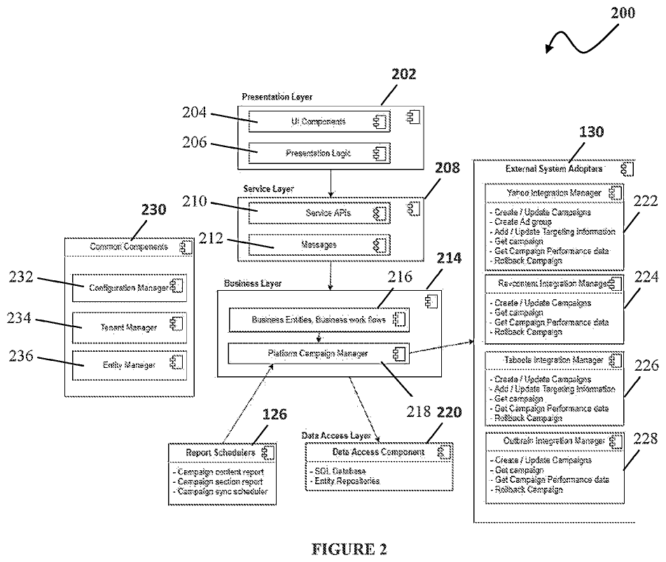

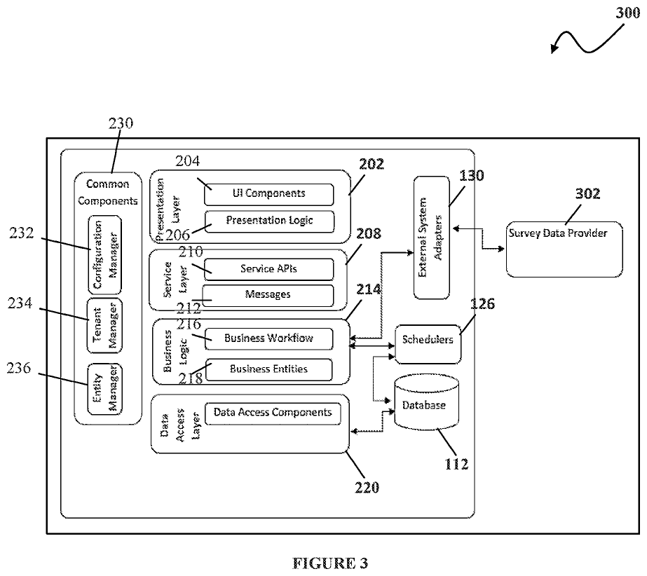

FIG. 2 illustrates a schematic diagram (200) depicting interconnection of various layers of the computer implemented platform of FIG. 1, according to an exemplary implementation of the present invention. FIG. 3 illustrates a schematic diagram depicting logical view of various layers and components, according to an exemplary implementation of the present invention.

In an embodiment, components of the processing engine (106) of the platform (100), as shown in FIG. 1, is arranged at various layers. In one embodiment, a presentation module (118) is located at a presentation layer (202), a service module (120) is located at a service layer (208), a logic creation module (122) is located at a business layer (214), and a data access module (124) is located at a data access layer.

The presentation layer (202) is configured to handle requests made from a client to a server. In an embodiment, one or more computing devices (102) (as shown in FIG. 1) is located at client side, and the processing engine (106) is located at server side, in a client-server arrangement. The presentation layer (202) includes User Interface (UI) components (204) and a presentation logic (206), which allow more robust and richer graphical user interface (GUI) implementation. Additionally, as most of the data is getting cached locally on the first access subsequent access result in less stress to the server and more lively experience for the end user. The presentation layer (202) is further configured to register and manage new users (for example, client), and for each client, the presentation layer (202) is configured to allow to manage user and role, advertiser and brand, campaign, and gives consolidated view of campaign performance across multiple platforms.

The service layer (208) includes service APIs (210) and messages (212). The service layer (208) exposes programming interfaces through which third party communication can happen. The service layer (208) provides authentication mechanism which helps to restrict unauthenticated and unauthorized access. The service layer (208) contains different API controller(s) (for example, service APIs (210)) for different business entities. The service layer (208) contains a unity container which holds the relationship between abstraction layer of data source and data source layer. These data mappers create a layer of indirection between the business layer and data source layer. The service layer (208) is configured to manage all the entities from the product, survey and master data, and campaigns on respective platform.

The business layer (214) includes business entities, business workflows (216) and a platform campaign manager (218). The business layer (214) contains business logic rules that control and govern the way information is processed. The business layer (214) also contains model classes for each business entity. The information about an entity is passed through the methods by passing the corresponding business models as parameter. The business layer (214) creates data mapper from a unity container passed through the service layer (208). The transactions do not know about the structure of the data source as well as the different queries to access the information.

The data access layer (220) contains interfaces and classes that define the technical services infrastructure used to store persistent data. The classes used inside this layer are responsible for the communication with database (112) (as shown in FIG. 1). The data access layer (220) contains data access component such as a SQL database, and entity repositories.

The one or more report schedulers (126) run continuously based on schedule intervals to fetch report data from integrated platforms. The report schedulers (126) include campaign content report, campaign section report, and a campaign synchronization scheduler.

The external adaptors (130) is also known as external system adapters. The external system adapters (130) are defined against each integrated platform. Each adapter contains classes which communicates with integrated platforms via platform APIs. For example, the external system adaptors (130) includes a Yahoo Integration Manager (222), a Revcontent Integration Manager (224), a Taboola Integration Manager (226), and an Outbrain Integration Manager (228). The Yahoo Integration Manager (222) is configured to create/update campaigns, create advertisement groups, add/update targeting information, get campaign, get campaign performance data, and rollback campaign. The Revcontent Integration Manager (224) is configured to create/update campaigns, get campaign, get campaign performance data, and rollback campaign. The Taboola Integration Manager (226) is configured to create/update campaigns, create advertisement groups, add/update targeting information, get campaign, get campaign performance data, and rollback campaign. The Outbrain Integration Manager (228) is configured to create/update campaigns, get campaign, get campaign performance data, and rollback campaign.

A survey data provider (302) is configured to get survey report data via various jobs. These jobs can be web jobs, which run continuously based on schedule intervals to fetch and manage survey report data from integrated platforms.

The other common components (230) includes a configuration manager (232), a tenant manager (234), and an entity manager (236). The configuration manager (232) manages configuration of the components. The tenant manager (234) manages tenants. The entity manager (236) manages a plurality of entities.

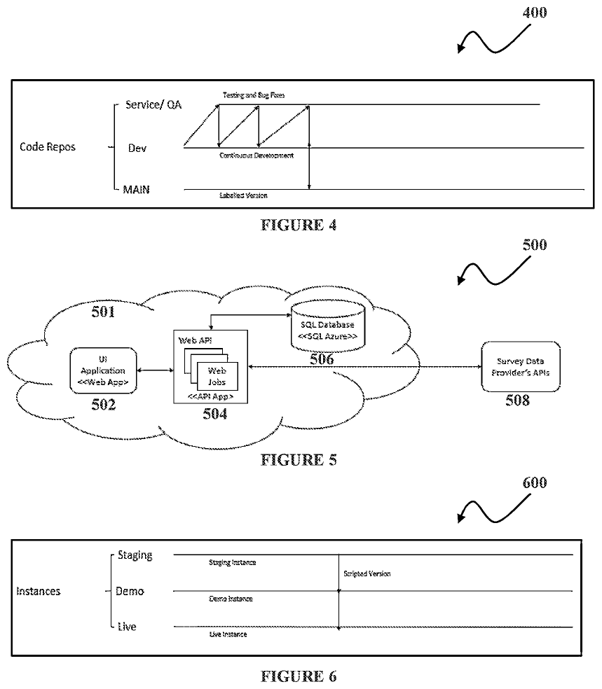

FIG. 4 illustrates a schematic diagram (400) depicting directory structure and source files maintained on a server, according to an exemplary implementation of the present invention.

FIG. 4 describes how directory structure and source files are maintained on the server. The server can be a Team Foundation Server (TFS) server. In the source files directory structure, the source files are maintained into three different branches: Service/QA (Quality Assurance), Dev, and Main. The Dev branch is responsible for continuous development of the product. The Service branch gets derived after certain features are completed on Dev environment. Once the branch is derived, all bugs related to developed features are getting fixed on current service branch. Once the agreed features are developed and tested, the Main branch gets derived from the Service branch. After this, Main branch gets deployed on production instance. Further, Structured Query Language (SQL) files are maintained along with source files on the TFS server. These files are responsible for creating tables and other database objects. Some of the tables are filled with some meaningful information use for testing.

FIG. 5 illustrates a schematic diagram depicting a deployment view (500) of the computer implemented platform of FIG. 1, according to an exemplary implementation of the present invention.

In an exemplary embodiment, the platform is deployed on, but is not limited to, Microsoft Azure cloud environment (501). A Web App (502) is an UI application which is installed on Web App service. The Web App (502) gets rendered on end user's web browser. An API App (504) is a service application which is installed on the API App service. All the requests through the Web App (502) or third-party applications are served by the API App (504). The continuous processes (Web jobs) gets managed by the API App (504). The database (for example, an SQL database) (506) files get executed on SQL service. Any user who have access to create the database objects can create/modify database objects. The concurrency and regular database backups are maintained by SQL database (506).

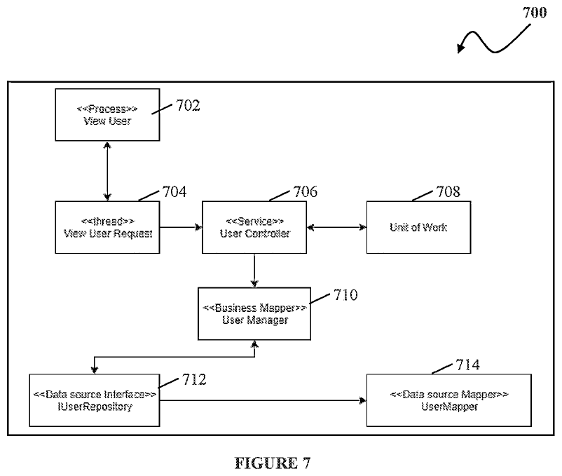

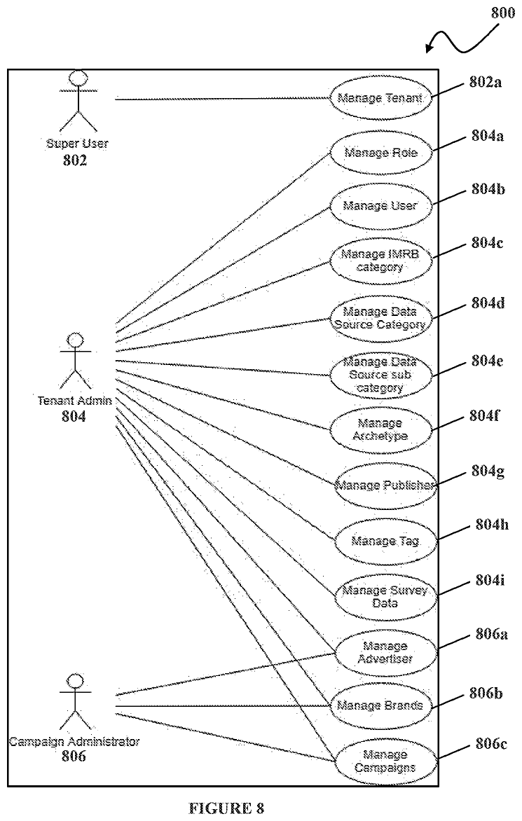

FIG. 6 illustrates a schematic diagram depicting instance details (600), according to an exemplary implementation of the present invention.

In FIG. 6, there are three instances at different layers including Staging, Demo, and Live. The Staging instance is used for the testing of newly developed features and its bugs. The Production/Live instance is the actual instance used by end user of the product. The Demo instance is the replica of production instance with some scripted code. This instance typically used by marketing stakeholders to demonstrate the capability of the product.

FIG. 7 illustrates a workflow diagram (700) depicting execution and interaction of the computer implemented platform of FIG. 1, according to an exemplary implementation of the present invention.

FIG. 7 illustrates displaying the responsibilities and collaborations among processes and threads of the platform (100) of FIG. 1 as well as allocation of logical elements to them. Following task shows, processes and threads that are involved in the execution and interaction of the platform (100). The workflow (700) illustrates a request (704) which is initialized by an authorized user (as shown at a step (702) to gain detail of specific user account. The user launches a web browser located on remote computer which creates a web client process. By selecting view user option (702), the web client creates process and sends a request (704) to web server process which remains online (706, 708, and 710). This request thread remains in the memory (712) until a result is received from the web server. The platform then uses user mapper (714).

FIG. 8 illustrates a use case diagram (800) depicting stakeholders' details, according to an exemplary implementation of the present invention.

The use case diagram (800) describes a view of platform's architecture that covers the general behavior from the point of view of the involved stakeholders. This view exposes the set of use cases that defines the core functionality of the platform. There are three types of stakeholders, such as a Super User (802), a Tenant Admin (804), and a Campaign Administrator (806).

The Super User (802) includes a Manage Tenant (802a), which is a privileged user (Super Administrator) and can manage the tenants. Along with tenant creation, the admin user for that tenant also gets created.

The Tenant Admin (804) includes a Manage Role (804a), a Manage User (804b), a Manage IMRB category (804c), a Manage Data Source Category (804d), a Manage Data Source Sub Category (804e), a Manage Archetype (804f), a Manage Publisher (804g), a Manage Tag (804h), a Manage Survey Data (804i), a Manage Advertiser (806a), a Manage Brands (806b), and Manage Campaigns (806c). The Manage Role (804a) can manage roles of various users. The Manage User (804b) is privileged user that can create users after the requested information provided to the platform (100) of FIG. 1. If the requested information does not meet the requirement criteria, then the display unit (104), as shown in FIG. 1, displays the warning/error messages. The Manage IMRB category (804c) is a privileged user that can manage IMIRB Category. The IMIRB category has mapping with Data source category that is used in the campaign creation. The Manage Data Source Category (804d) is a privileged user that can create the data source category by upload the IMIRB data source category mapping file that is used in the campaign creation. The Manage Data Source Subcategory (804e) is a privileged user that can create the Data Source Subcategory by uploading the IMRB data source category mapping file. The Manage Archetype (804f) is a privileged user that can manage the archetypes. The archetypes are inserted from backed first time as master data. New archetype can be managed by the user. The archetype is mapped with the data source category and with IMIRB category via data source category. The Manage Publisher (804g) is a privileged user can manage the publishers. The publisher's performance data fetch by the web jobs via APIs. The web job also inserts new publisher that is not in the platform (100). The user has option to upload file for insert publisher's performance data for selected time-period. The Manage Tag (804h) is a privileged user that can manage the tags. The web job of crawling website inserts tags to the platform (100). The tag cloud is mapped data source category and Data Source Subcategory, that used while campaign creation. The Manage Survey Data (804i) is a privileged user they can the survey data by uploading file. The archetype category score, archetype subcategory score, archetype universe, archetype category ration and archetype category content are used while campaign creation.

The Campaign Administrator (806) also includes Manage Advertiser (806a), Manage Brands (806b), and Manage Campaigns (806c). The Manage Advertiser (806a) is a privileged user that can manage advertisements. The Manage Brands (806b) is a privileged user that can manage brands of products. The Manage Campaign (806c) is a privileged user that can manage campaigns those gets created after the requested information provided to the platform (100).

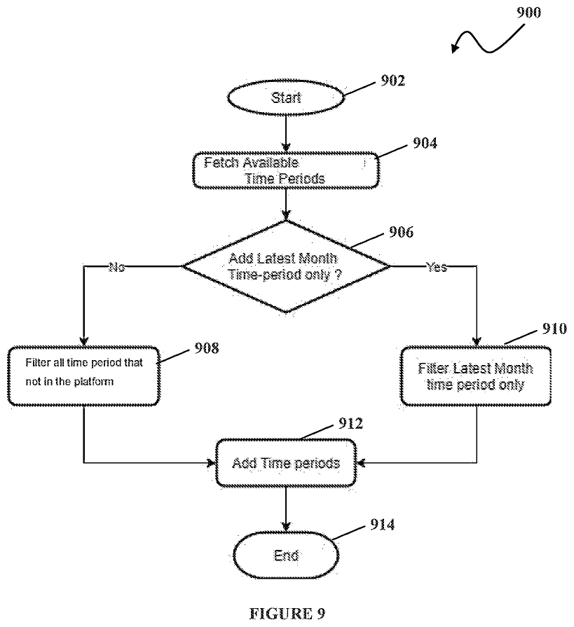

FIG. 9 illustrates a flow diagram (900) depicting adding time period, according to an exemplary implementation of the present invention.

FIG. 9 describes a flow of adding time period. The flow diagram (900) starts at a step (902). At a step (904), the platform (100) fetches available time periods. In an exemplary embodiment, a web job can call a logic creation module (122) or Business Logic Layer's (214) manager to get available time periods. The logic creation module (122) again call API to get time periods. At a step (906), check whether to add latest month time period only. In an embodiment, at a step (908), filter all time period that are not in the platform (100), if latest month time period is not added. At a step (910), filter latest month time period only, if latest month time period is added. At a step (912), add time periods, and the flow stops at a step (914). If it is required to add only the latest month time period, then the logic creation module (122) adds only latest month time period to list. If it is required to add all time periods, then prepare the list of time periods that are not available in the database (112). The data access module (124) adds the time-period that prepared at (906), (908), and (910) steps. The web job then waits for next execution cycle.

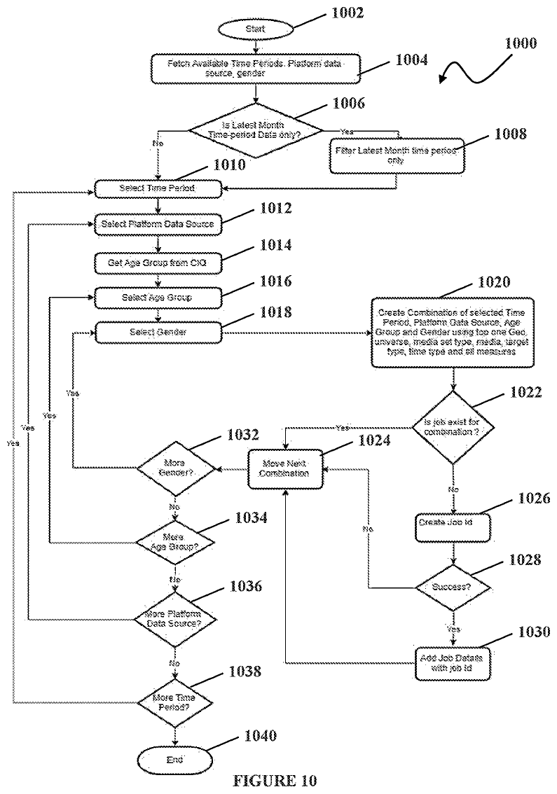

FIG. 10 illustrates a flow diagram (1000) depicting creating jobs, according to an exemplary implementation of the present invention.

The flow diagram (1000) starts at a step (1002). At a step (1004), the platform (100) fetches available time periods, platform data sources, and gender. At a step (1006), the platform checks whether the latest month time period data only. If there is latest month time period data only, then the platform (100) filters latest month time period only (as shown at a step (1008)), else select time period (as shown at a step (1010)). At a step (1012), the platform (100) selects platform data source. At a step (1014), the platform (100) gets age group of the users. At a step (1016), the platform (100) selects an age group. At a step (1018), the platform (100) selects gender. At a step (1020), the platform (100) creates combination of selected time period, platform data source, age group, and gender using top one Geo, universe, media set type, media, target type, time type, and all measures. At a step (1022), the platform (100) checks whether the job is existing for combination. If it is not existing, the platform (100) creates a job ID (as shown at a step (1026)), or else move to next combination (as shown at a step (1024)). If the job ID is created in the step (1026), the platform (100) checks whether it is success or not (as shown at a step (1028). If it is success, then add job details with the job ID, and move to the step (1024). If it is not success, move to the step (1024). At a step (1032), the platform (100) checks whether there is more gender. If there is more gender, then the platform (100) selects gender (as shown at the step (1018). If there is no more gender, the platform (100) again checks more age group, as shown at a step (1034). If there is more age group, the platform (100) selects age group from the step (1016). If there is no more age group, then the platform (100) again checks more platform data source. If there is more data source, the platform (100) selects a platform data source from the step (1012). If there is no more data source, the platform (100) checks whether there is more time period. If there is more time period, the platform (100) selects a time period from the step (1010), else stops the process at a step (1040).

In an exemplary embodiment, a web job calls Business Logic Layer's manager to get available time periods, platform data source, gender from the database (112). If it is required to create jobs for latest month time period only then, filter the time period and select latest month time period only to create a job. If it is required to create jobs for all time period, then use all time period to create jobs. For creating jobs, loop on time period that is filter is based on (1004) and (1006) steps. The platform (100) then select the platform data source one by one using looping. The platform (100) gets all age groups master data from the database (112) for the selected platform data source form step (1014). The platform (100) performs loop on all gender and age group and select gender and age group. The platform (100) creates a combination of the selected platform data source, age groups, gender, media set type, geo, media, time types, target types and all measures. If job exists for above combination, then step (1024) move to next combination. If job does not exist, then call API to create a job. If job is successfully created, then add job details with job id to the database (112) else move to next combination till combination exist. The web job waits for next execution cycle.

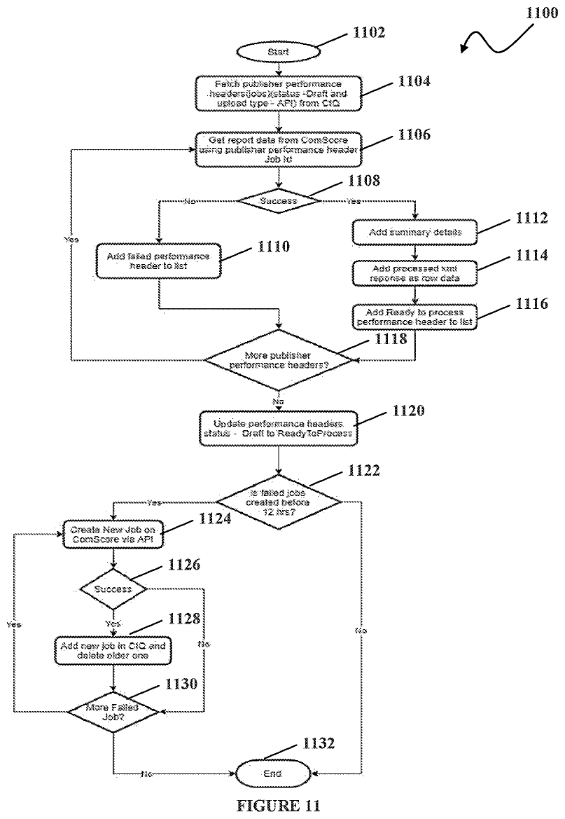

FIG. 11 illustrates a flow diagram (1100) depicting fetching of publisher performance report data, according to an exemplary implementation of the present invention.

The flow diagram (1100) starts at a step (1102). At a step (1104), the platform (100) fetches publisher performance headers (jobs) (status-draft and upload type-API) from the database (112). At a step (1106), the platform (100) gets report data from the database (112) using publisher performance header job ID. At a step (1108), the platform (100) checks whether it is succeeded or not. If it is successes, the platform (100) adds summary details (1112). If it is not succeeding, the platform (100) adds failed performance header to a list, as shown at a step (1110). At a step (1114), the platform (100) adds processed xml responses as row data. At a step (1116), the platform (100) adds ready to process performance header to list. At a step (1118), the platform (100) checks more publisher performance headers. If there are more headers, go to the step (1106), else update performance headers status, which is a draft to ready to process, as shown at a step (1120). At a step (1122), the platform (100) checks is failed jobs created before 12 hours. If it is not failed, then the platform (100) stops the process at a step (1132), else create a new job on the database (112) via API, as shown at a step (1124). At a step (1126), the platform (100) checks whether it is success or not. If it is success, then the platform (100) adds the new job in the database (112) and delete the older one, as shown at a step (1128). At a step (1130), the platform (100) checks whether more failed job or not. If the more job failed, go to step (1124), else stop the process at the step (1132).

In an exemplary embodiment, a web job calls a Business Logic Layer's manager to fetch publisher performance data from the database (112). In the business layer, the platform (100) fetches the publisher performance that have status draft and type is API. The platform (100) then call the API for fetching publisher performance report data by passing job id as parameter. If API is successfully executed, then the platform (100) adds summary details i.e. aggregate values from data access layer to the database (112). If API is successfully executed, then add response to publisher row data from data access layer. If API is successfully executed, then add performance header(job) to ready process performance header list and move for next job execution. If API is not successfully executed, then add that performance header(job) to failed performance header list and move for next job execution. The platform (100) updates the performance header status Draft to ReadyToProcess from the data access layer. The platform (100) checks if fail job created before 12 hours, then create new job using existing combination via API from the business logic layer. If job created successfully, the platform (100) deletes older job and add new job with job id from data access layer. The platform (100) then repeats (1122) and (1124) for all failed job. The web job the waits for next execution cycle.

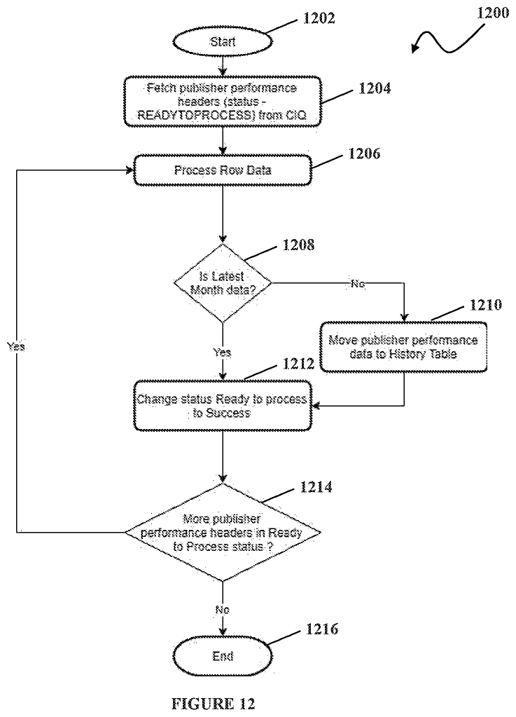

FIG. 12 illustrates a flow diagram (1200) depicting processing of publisher performance data, according to an exemplary implementation of the present invention.

The flow diagram (1200) starts at a step (1202). At a step (1204), the platform (100) fetches publisher performance header status from the database (112). At a step (1206), the platform (100) processes row data. At a step (1208), the platform (100) checks the latest month data. If no latest month data, then the platform (100) moves to publisher performance data to history table (as shown at a step (1210), else change status Ready to process to Success, as shown at a step (1212). At a step (1214), the platform (100) checks whether more publisher performance headers in ready to process state or not. If it is there, the platform goes to step (1206), else stops the process at a step (1216).

In an exemplary embodiment, a web job calls Business Logic Layer's manager to process publisher performance row data. The platform (100) fetches the publisher performance headers that have ready to process status from the database (112) from the data access layer. The process row data adds the data to Publisher Performance Detail table. The platform (100) checks the month of data and the latest month, if the data is not of the latest month then move data to publisher performance header history table and set status of the publisher performance header (job) ReadyToProcess to success. The platform (100) check the month of data and the latest month, if data is of the latest month then set status of the publisher performance header (job) ReadyToProcess to success. The platform (100) repeat the steps (1206) to (1212) for all publisher performance headers. The web job waits for next execution cycle.

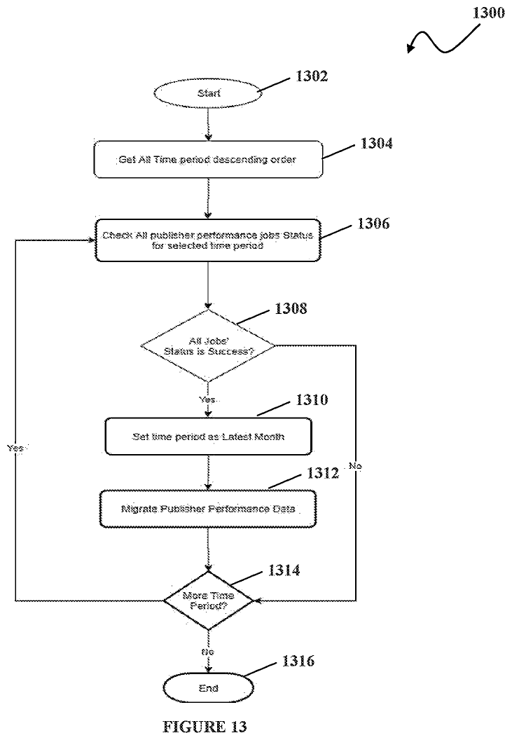

FIG. 13 illustrates a flow diagram (1300) depicting processing of set latest month, according to an exemplary implementation of the present invention.

The flow diagram (1300) starts at a step (1302). At a step (1304), the platform (100) gets all time period descending order. At a step (1306), the platform (100) checks all the publisher performance jobs status for selected time period. At a step (1308), the platform (100) checks whether all jobs status is success. If it is success, the platform (100) set time period as latest month, as shown at a step (1310). If it is not success, the platform (100) checks more time period, as shown at a step (1314). At a step (1312), the platform (100) migrates publisher performance data. At a step (1314), the platform (100) again checks more time period. If there is more time period, the platform (100) goes to the step (1306) and repeat the process, else stop the process at a step (1316).

In an exemplary embodiment, a web job calls Business Logic Layer's manager to set latest month in the database (112). To set latest month, get all time period from the database (112) from data access layer. The platform (100) checks the all publisher performance header's status for selected time period. If all the job's status is success, then the platform (100) sets the time period as latest month and also migrate data of the that time period else check next step. The platform (100) else checks the next time period available then repeat step (1306). The web job waits for next execution cycle.

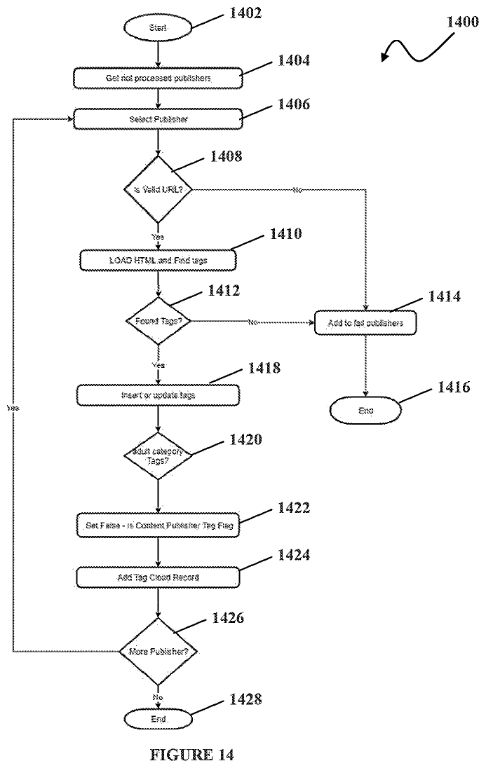

FIG. 14 illustrates a flow diagram (1400) depicting processing of crawling tag from one or more sources, according to an exemplary implementation of the present invention.

The flow diagram (1400) starts at a step (1402). At a step (1404), the platform (100) gets not processed publishers. At a step (1406), the platform (100) selects publishers. At a step (1408), the platform (100) checks the valid URL. If there is no valid URL, the platform (100) adds to fails publishers, as shown at a step (1414), else stops the process at a step (1416). If there is valid URL, the platform (100) loads HTML and finds tags, as shown at a step (1410). At a step (1412), the platform (100) checks whether tags are found or not. If tags are not found, go to step (1414). If tags are found, the platform (100) inserts or updates tags, as shown at a step (1418). At a step (1418), the platform (100) checks adult category tags. If the adult category tags are available, the platform (100) sets false-Is content publisher tag flag, as shown at a step (1422). At a step (1424), the platform (100) adds tag cloud record. At a step (1426), the platform (100) checks more publisher. If there are more publisher, go to the step (1406) and repeat the steps, else stop the process at a step (1428).

In an exemplary embodiment, a web job calls Business Logic Layer's manager to crawl a website. The platform (100) get all not processed publisher from the database (112) from the data access layer. The platform (100) selects publisher from the list and check is URL is valid for selected publisher. If not, a valid URL then add that publisher to failed publisher list. The platform (100) loads html and finds tags from website URL from the business layer. If not found tags from that website, add website to failed publisher list. The platform (100) adds or updates existing tag from the data access layer. If the tag from the adult category, then set “IsContentPublisher” flag false so it will not appear in the UI. The platform (100) adds that tag to tag could record with mapping of publisher data source category and data source subcategory. If there is more publisher to process, then repeat step (1406). The web job waits for next execution cycle.

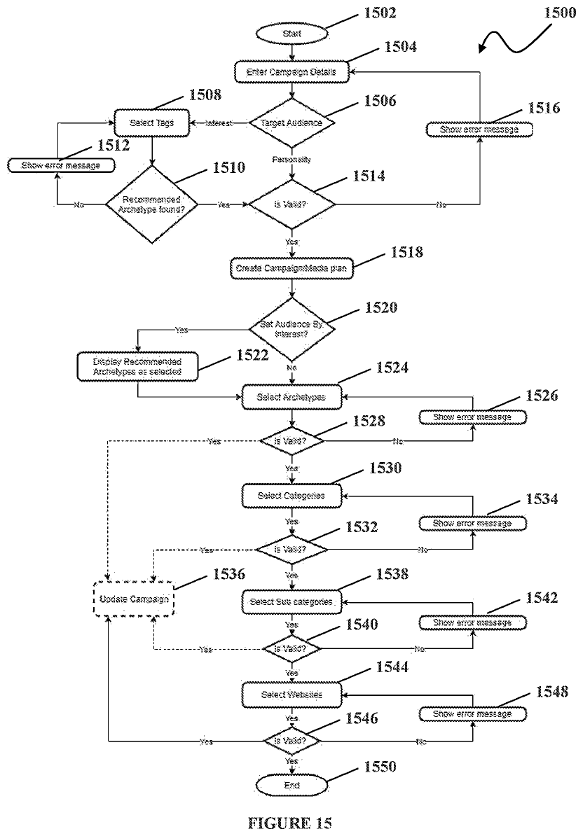

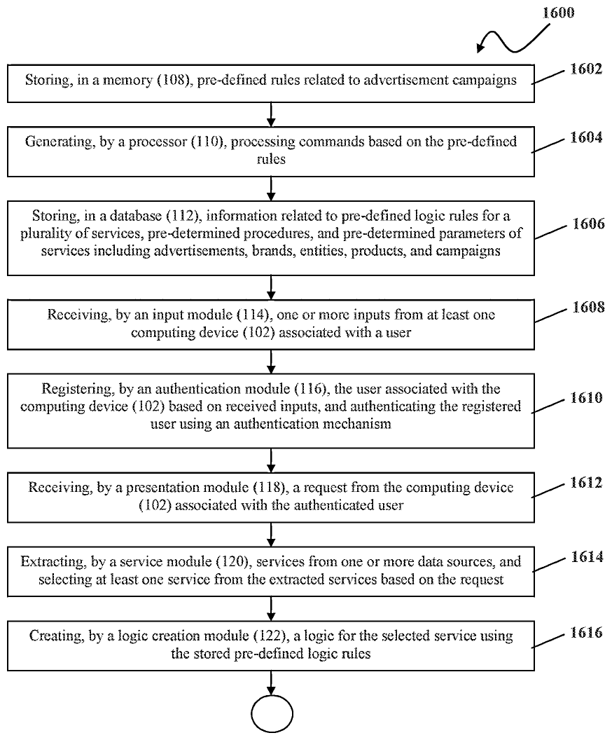

FIG. 15 illustrates a flow diagram (1500) depicting creating advertisement campaigns with media plan, according to an exemplary implementation of the present invention.

The flow diagram (1500) starts at a step (1502). At a step (1504), the platform (100) enters campaign details (1504). At a step (1506), the platform (100) checks target audience. If the target audience is interested, then the platform (100) selects tags, as shown at a step (1508). If the target audience has a personality, the platform (100) checks whether it is valid, as shown at a step (1514). If it is not valid, the platform (100) shows an error message, as shown at a step (1516), and go to step (1504) and repeat the process. If it is valid, the platform (100) creates campaign/media plan, as shown at a step (1518). At a step (1510), the platform (100) checks whether recommended Archetype found or not. If it is not found, then the platform (100) shows an error message, as shown at a step (1512), and go to step (1508). If it is founded, the platform (100) again checks whether it is valid or not, as shown at a step (1518), and move to the step (1518). At a step (1520), the platform (100) checks whether the set audience by interest or not. If yes, then the platform (100) displays recommended Archetypes as selected, as shown at a step (1522), else, the platform (100) selects Archetype, as shown at a step (1524). At a step (1528), the platform (100) checks whether it is valid or not. If it is valid, the platform (100) selects categories, as shown at a step (1530) or updates campaign (as shown at a step (1536)), else show an error message, as shown at a step (1526). At a step (1532), the platform (100) checks whether it is valid or not. If it is valid, the platform (100) selects sub-categories, as shown at a step (1538) or updates campaign (as shown at a step (1536)), else show an error message, as shown at a step (1534). At a step (1540), the platform (100) checks whether it is valid or not. If it is valid, the platform (100) selects websites, as shown at a step (1544) or updates campaign (as shown at a step (1536)), else show an error message, as shown at a step (1542). At a step (1546), the platform (100) checks whether it is valid or not. If it is valid, the platform (100) stops the process at a step (1550) or updates campaign (as shown at a step (1536)), else show an error message, as shown at a step (1548).

In an exemplary embodiment, the platform (100) enter campaign details from the presentation layer. The platform (100) selects target audience like age, gender and audience by from the presentation layer. If audience by is Interest, then the platform (100) selects tags from the presentation layer. If recommended Archetype is not found from selected tags, then the platform (100) throws exception message on the presentation layer. If audience by is personality selected go next step. The platform (100) validates the campaign details and the targeting audience, if all are valid then save media plan and go to next step else throw exception message. The Archetypes screen, if the previous screen audience is selected by interest, then the platform (100) recommends Archetype, based on the survey data that called recommended Archetype. The logic behind the Archetypes recommendation are:
a. The data source categories for selected tags from a tag cloud.
b. The IMRB category and data source mapping for the selected tags.
c. The Archetype mapping and score for data source categories is above 100.
d. The Archetypes' specific archetype ration is greater than overall Archetype ration and appearing as recommended Archetypes.
   The Archetypes screen, if in previous screen audience by personality selected, then the platform (100) do not display selected archetypes. If archetype selection is not valid, then the platform (100) shows exception message on the presentation layer. If archetype selection is valid, then the platform (100) saves media plan and go ahead to next screen. The selection of category screen displays the category of selected archetypes is based on the IMRB Category mapped, and is with data source category. The selection of category screen displays, if selected by a targeting interest, on top selected IMRB category from selected tag is shown regardless of its score value. If category selection is not valid then the platform (100) shows exception message on presentation layer. If category selection is valid then the platform (100) saves media plan and go ahead to next screen. The subcategory selection screen, all the subcategories of all categories (except adult sub category) from selected archetypes and whose publisher performance data of latest month (only multiplatform data is considered) is available are displayed in subcategory screen for selection. There are two concepts for matching subcategory;
Primary Match: Subcategories of selected IMRB (Mapping with data source category) categories from category tab is marked as primary match; and
Broad Match: Subcategories of non-selected IMRB (Mapping with data source category) categories from category tab is marked as broad match.
   If subcategory selection is not valid, then the platform (100) shows exception message on presentation layer. If subcategory selection is valid then the platform (100) saves media plan and go ahead to next screen. Websites whose data is available for selected categories, subcategories, gender and age group for the latest month is available in websites screen for targeting. If websites selection is not valid, then the platform (100) shows exception message on the presentation layer. If websites selection is valid, then the platform (100) saves media plan.

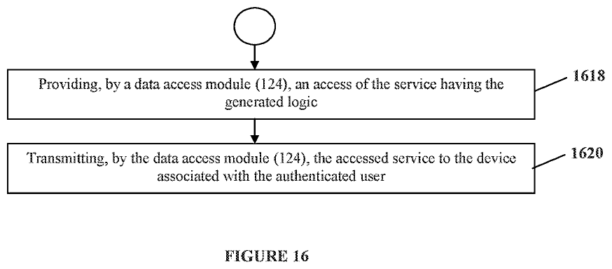

FIG. 16 illustrates a flowchart (1600) depicting a computer implemented platform for one or more advertisement campaigns, according to an exemplary implementation of the present invention.

The flowchart (1600) starts at a step (1602), storing, in a memory (108), pre-defined rules related to advertisement campaigns. In an embodiment, a memory (108) is configured to store pre-defined rules related to advertisement campaigns. At a step (1604), generating, by a processor (110), processing commands based on the pre-defined rules. In an embodiment, a processor (110) is configured to generate processing commands based on the pre-defined rules. At a step (1606), storing, in a database (112), information related to pre-defined logic rules for a plurality of services, pre-determined procedures, and pre-determined parameters of services including advertisements, brands, entities, products, and campaigns. In an embodiment, a database (112) is configured to store information related to pre-defined logic rules for a plurality of services, pre-determined procedures, and pre-determined parameters of services including advertisements, brands, entities, products, and campaigns. At a step (1608), receiving, by an input module (114), one or more inputs from at least one computing device (102) associated with a user. In an embodiment, an input module (114) is configured to receive one or more inputs from at least one computing device (102) associated with a user. At a step (1610), registering, by an authentication module (116), the user associated with the computing device (102) based on received inputs, and authenticating the registered user using an authentication mechanism. In an embodiment, an authentication module (116) is configured to register the user associated with the computing device (102) based on received inputs, and authenticating the registered user using an authentication mechanism. At a step (1612), receiving, by a presentation module (118), a request from the computing device (102) associated with the authenticated user. In an embodiment, a presentation module (118) is configured to receive a request from the computing device (102) associated with the authenticated user. At a step (1614), extracting, by a service module (120), services from one or more data sources, and selecting at least one service from the extracted services based on the request. In an embodiment, a service module (120) is configured to extract services from one or more data sources, and select at least one service from the extracted services based on the request. At a step (1616), creating, by a logic creation module (122), a logic for the selected service using the stored pre-defined logic rules. In an embodiment, a logic creation module (122) is configured to create a logic for the selected service using the stored pre-defined logic rules. At a step (1618), providing, by a data access module (124), an access of the service having the generated logic. In an embodiment, a data access module (124) is configured to provide an access of the service having the generated logic. At a step (1620), transmitting, by the data access module (124), the accessed service to the device associated with the authenticated user. In an embodiment, the data access module (124) is configured to transmit the accessed service to the device associated with the authenticated user.

In an embodiment, the platform (100) may be implemented over a cloud computing platform.

In an embodiment, the platform (100) provides login screen to a user and by entering valid URL in address bar. The user may be able to login to application with valid credentials. The user may be able to regenerate your password by clicking on forgot password link. After entering valid email address, reset password button may be enabled and the user may view successful message as “Please check mail to reset password”. The user may click on ‘ok’ button to view login screen. To reset password, the user may login with given mail id and go to mail, may click on link and generate new password. After entering same password in to the new and confirm passwords fields, the create password button may be enabled. After clicking on create password button, user may view successful message as “Password created successfully”. If user click on ‘ok’ button, then user may view login screen. If user do not enter same new and confirm password in respective fields then user may view error message below respective fields and create password button should not get enable. The system and the method thereof also provide User Profile function, Change Password function.

In an embodiment, the platform (100) provides a dashboard, Managed Tenant functionality, Manager User functionality, Report User functionality, Client Admin/Campaign Admin User functionality, Self-Served Tenant (Agency/Advertiser) functionality, Client Admin/Campaign Admin User functionality and the dashboard may be available for any type of user which belongs to any types of tenants. The data should be available based on role of the user. Following are the details to view the required data:
The dashboard has data frequencies like by Day, Week (From Sunday to Saturday) and Month which are applicable for all categories. The dashboard also contains other filters to filter the data.
The dashboard has “Performance Trend” graph which should display top 10 items from selected category.
The dashboard has “Performance Trend” graph which should display comparison between different performance metrics.
The dashboard has performance metric table based on selected category.
Content wise data is not available for the Colombia platform. Hence, there should be discrepancy in the calculated data.
Publisher wise data is only available for Outbrain and Taboola platform. Hence, there should be discrepancy in the calculated data.
Section wise data is only available for Outbrain platform. Hence, there should be discrepancy in the calculated data.

In an embodiment, the platform (100) provides an Interim dashboard. The Interim dashboard may be available only for managed type of tenant. Also, if any type of role gives privileges to interim dashboard menu and assign that role to existing/created new user then that user should view Interim dashboard menu below admin menu. On interim dashboard screen, with marginal data may be displayed in performance grid. Also, user may see actual values and interim dashboard values. Other functionalities may be same as dashboard.

In an embodiment, the user menu is available for managed and self-served type of tenant. Also, if any type of role gives privileges to user's menu and assign that role to existing/created new user then that user should view user's menu below admin menu.

In an embodiment, a role menu is available for managed and self-served type of tenant. Also, if any type of role gives privileges to role menu and assign that role to existing/created new user then that user may view role menu below admin menu.

In an embodiment, the platform (100) provides a credential menu, which may be available for managed and self-served type of tenant. Also, if any type of role gives privileges to platform credential menu and assign that role to existing/created new user then that user may view platform credential menu below admin menu.

In an embodiment, the platform (100) provides a group menu, which may be available only for managed type of tenant. Also, if any type of role gives privileges to user's menu and assign that role to existing/created new user then that user should view Group menu below admin menu.

In an embodiment, the platform (100) provides an industry type menu, which may be available only for managed type of tenant. Also, if any type of role gives privileges to industry type menu and assign that role to existing/created new user then that user may view industry type menu below admin menu.

In an embodiment, the platform (100) provides a segment menu, which may be available only for managed type of tenant. Also, if any type of role gives privileges to segment menu and assign that role to existing/created new user then that user may view segment menu below admin menu.

In an embodiment, the platform (100) provides a suspended activity master menu, which may be available only for managed type of tenant. Also, if any type of role gives privileges to suspended activity menu and assign that role to existing/created new user then that user may view Suspended activity menu below admin menu.

In an embodiment, the platform (100) provides a currency rate menu, which may be available only for managed type of tenant. Also, if any type of role gives privileges to suspended activity menu and assign that role to existing/created new user then that user may view currency rate menu below admin menu.

In an embodiment, the platform (100) provides a synchronization Campaign menu, which may be available for managed and self-served type of tenant. Also, if any type of role gives privileges to sync campaign menu and assign that role to existing/created new user then that user may view sync campaign menu below admin menu.

In an embodiment, the platform (100) provides an agency menu, which may be available for managed and self-served type of tenant. Also, if any type of role gives privileges to agency menu and assign that role to existing/created new user then that user may view agency menu below client menu.

In an embodiment, the platform (100) provides an advertiser menu, which may be available for managed and self-served type of tenant. Also, if any type of role gives privileges to advertiser menu and assign that role to existing/created new user then that user may view advertiser menu below client menu.

In an embodiment, the platform (100) provides a brand, which may be available for managed and self-served type of tenant. Also, if any type of role gives privileges to brand menu and assign that role to existing/created new user then that user may view brand menu below client menu.

In an embodiment, the platform (100) provides a campaign menu, which may be available for managed and self-served type of tenant. Also, if any type of role gives privileges to campaign's menu and assign that role to existing/created new user then that user may view campaign's menu below client menu.

In an embodiment, the platform (100) provides a report configurator menu, which may be available for managed and self-served type of tenant. Also, if any type of role gives privileges to report configurator menu and assign that role to existing/created user then that user may view report configurator menu below client menu.

In an embodiment, the platform (100) provides a Colombia excel upload menu, which may be available for managed and self-served type of tenant. Also, if any type of role gives privileges to Colombia excel upload menu and assign that role to existing/created user then that user may view Colombia excel menu below client menu.

In an embodiment, the platform (100) provides a Google analytics excel upload menu may be available for managed and self-served type of tenant. Also, if any type of role gives privileges to google analytics excel upload menu and assign that role to existing/created user then that user may view google analytics excel menu below client menu.

In an embodiment, the platform (100) provides a client management menu.

In an embodiment, if a user want to see platform activity grid then the user may need to have login credentials of managed and self-served type of tenant. The user may view columns as platform name, time interval, report type, last sync date and last item update date. As described in the embodiments above the present invention provides limitations as:
excel upload for any Content Discovery platform
download data by section wise, platform wise and by advertiser and by brand
interim dashboard—Special dashboard for agencies to manage arbitrage
report configurator—Customised dashboard for selected campaigns.
managed services—Managed services for clients can be run.
if client does not have platform access, then they can still use the platform (100) and method thereof
unified dashboard to view data from for all platforms and campaigns.

In some embodiments, the disclosed techniques can be implemented, at least in part, by computer program instructions encoded on a non-transitory computer-readable storage media in a machine-readable format, or on other non-transitory media or articles of manufacture. Such computing systems (and non-transitory computer-readable program instructions) can be configured according to at least some embodiments presented herein, including the processes shown and described in connection with Figures.

The programming instructions can be, for example, computer executable and/or logic implemented instructions. In some examples, a computing device is configured to provide various operations, functions, or actions in response to the programming instructions conveyed to the computing device by one or more of the computer readable medium, the computer recordable medium, and/or the communications medium. The non-transitory computer readable medium can also be distributed among multiple data storage elements, which could be remotely located from each other. The computing device that executes some or all of the stored instructions can be a microfabrication controller, or another computing platform. Alternatively, the computing device that executes some or all of the stored instructions could be remotely located computer system, such as a server.

Further, while one or more operations have been described as being performed by or otherwise related to certain modules, devices or entities, the operations may be performed by or otherwise related to any module, device or entity.

Further, the operations need not be performed in the disclosed order, although in some examples, an order may be preferred. Also, not all functions need to be performed to achieve the desired advantages of the disclosed platform and method, and therefore not all functions are required.

It should be noted that the description merely illustrates the principles of the present invention. It will thus be appreciated that those skilled in the art will be able to devise various arrangements that, although not explicitly described herein, embody the principles of the present invention. Furthermore, all examples recited herein are principally intended expressly to be only for explanatory purposes to help the reader in understanding the principles of the invention and the concepts contributed by the inventor(s) to furthering the art and are to be construed as being without limitation to such specifically recited examples and conditions. Moreover, all statements herein reciting principles, aspects, and embodiments of the invention, as well as specific examples thereof, are intended to encompass equivalents thereof.

1. A computer implemented method for one or more advertisement campaigns, said method comprising:
storing, in a memory, pre-defined rules related to advertisement campaigns; generating, by processor, processing commands based on said pre-defined rules;
storing, in a database, information related to pre-defined logic rules for a plurality of services, pre-determined procedures, and pre-determined parameters of services including advertisements, brands, entities, products, and campaigns;
receiving, by an input module, one or more inputs from at least one computing device associated with a user;
registering, by an authentication module, said user associated with said computing device based on received inputs, and authenticating said registered user using an authentication mechanism;
receiving, by a presentation module, a request from said computing device associated with said authenticated user;
extracting, by a service module, services from one or more data sources, and selecting at least one service from said extracted services based on said request;
creating, by a logic creation module, a logic for said selected service using said stored pre-defined logic rules;
providing, by a data access module an access of said service having said generated logic, and
transmitting, by said data access module, said accessed service to said device associated with said authenticated user.

2. The method as claimed in claim 1, wherein said method includes fetching, by a report scheduler, report data from said data sources based on pre-defined schedule intervals.

3. The method as claimed in claim 1, wherein said method includes capturing, by said input module, data from said computing devices and receiving said captured data as one or more inputs.

4. The method as claimed in claim 1, wherein said services include authorization and authentication services, tool services, technology services, exception handling services, inventory services, provisioning services, invoice services, and any commercial services.

5. The method as claimed in claim 1, wherein said method includes creating, by said logic creation module, said logic using said stored pre-determined procedures.

6. The method as claimed in claim 1, wherein said method includes registering, by said authentication module, said user based on the user's information, said information includes a username, a contact number, address, a unique identification number, a user role, location, gender, interests, and any combinations thereof.

7. The method as claimed in claim 1, wherein said method includes registering by said authentication module, said user based on associated details related to products, brands, advertisements related information, audiences, publishers, and campaign.

8. The method as claimed in claim 1, wherein said method includes integrating and managing, by an external adaptor, said one or more data sources.

9. The method as claimed in claim 1, wherein said method includes aggregating, by a data aggregator, campaign data of said services having said created logic.

10. The method as claimed in claim 9, wherein said method comprising:
applying at least one filter by a category, frequency, start date, end date, data sources advertisers, brands, a pre-determined campaign status, campaign or advertisement contents;
setting a pre-defined currency unit for conversion of current currency using a current currency rate; and
aggregating said campaign data of said services.

11. The method as claimed in claim 1, wherein said method includes displaying, by a display unit said aggregated data in the form of grid, matrix, a list, a chart, a table, a graph, and any combinations thereof.

12. A computer implemented platform for one or more advertisement campaigns, said platform comprising:
one or more computing devices, wherein each computing device is associated with a user;
a processing engine configured to cooperate with said computing devices, said processing engine comprising:
a memory configured to store pre-defined rules related to advertisement campaigns;
a processor configured to cooperate with said memory, said processor configured to generate processing commands based on said pre-defined rules;
a database configured to store information related to pre-defined logic rules for a plurality of services, pre-determined procedures, and pre-determined parameters of services including advertisements, brands, entities, products, and campaigns;
an input module configured to receive one or more inputs from at least one computing device associated with said user;
an authentication module configured to cooperate with said input module, said authentication module configured to register said user associated with said computing device based on received inputs, and authenticate said registered user using an authentication mechanism;
a presentation module configured to cooperate with said authentication module, said presentation module configured receive a request from said computing device associated with said authenticated user;
a service module configured to cooperate with said presentation module, said service module configured to extract services from one or more data sources, and select at least one service from said extracted services based on said request;
a logic creation module configured to cooperate with said service module, said logic creation module configured to create a logic for said selected service using said stored pre-defined logic rules; and
a data access module configured to cooperate with said logic creation module, said data access module configured to provide an access of said service having said generated logic, and transmit said accessed service to said computing device associated with said authenticated user.

13. The platform as claimed in claim 12, wherein said processing engine includes a report scheduler, said report scheduler is configured to fetch report data from said data sources based on pre-defined schedule intervals.

14. The platform as claimed in claim 12, wherein said input module is configured to capture data from said computing devices, and receive said captured data as one or more inputs.

15. The platform as claimed in claim 12, wherein said logic creation module is configured to create said logic using said stored pre-determined procedures.

16. The platform as claimed in claim 12, wherein said platform includes a client-server arrangement.

17. The platform as claimed in claim 16, wherein said one or more devices are located at a client side, and said processing engine is located at a server side in said client-server arrangement.

18. The platform as claimed in claim 12, wherein said authentication module is configured to register said user based on the user's information, said information includes a username, a contact number, address, a unique identification number, a user role, location, gender, interests, and any combinations thereof.

19. The platform as claimed in claim 12, wherein said authentication module is configured to register said user based on associated details related to products, brands, advertisements related information, audiences, publishers, and campaign.

20. The platform as claimed in claim 12, wherein said platform comprising an external adaptor configured to integrate and manage said one or more data sources.

21. The platform as claimed in claim 12, wherein said processing engine includes a data aggregator is configured to aggregate campaign data of said services having said created logic.

22. The platform as claimed in claim 21, wherein said data aggregator is configured to:
apply at least one filter by a category, frequency, start date, end date, data sources advertisers, brands, a pre-determined campaign status, campaign or advertisement contents;
set a pre-defined currency unit for conversion of current currency using a current currency rate; and
aggregate said campaign data of said services.

23. The platform as claimed in claim 1, wherein said one or more devices include a display unit configured to display said aggregated data in the form of grid, matrix, a list, a chart, a table, a graph, and any combinations thereof.
